(19) United States
(12) Patent Application Publication
(10) Pub. No.: US 2019/0017468 A1
(43) Pub. Date: Jan. 17, 2019

(54) Gimballed Augmentation Shroud

(71) Applicant: JETOPTERA, Inc., Edmonds, WA (US)

(72) Inventor: Andrei Evulet, Edmonds, WA (US)

(21) Appl. No.: 16/033,197

(22) Filed: Jul. 12, 2018

Related U.S. Application Data
(60) Provisional application No. 62/531,817, filed on Jul. 12, 2017.

(51) Int. Cl. F02K 1/00; F02K 1/82; B64D 27/10

(52) U.S. Cl. CPC F02K 1/004; F02K 1/82; B64D 27/10; F05D 2250/43; F05D 2240/128; F05D 2250/61; F05D 2220/323

(57) ABSTRACT

A system for enhancing the thrust produced by an aircraft propulsion element having a propulsion fluid outlet includes a shroud element having an inlet, an outlet and a diffusing section positioned between the shroud element inlet and shroud element outlet. The shroud element is coupled to the aircraft such that the diffusing section is positioned directly downstream of the propulsion fluid outlet. At least one actuator is operable to rotate the shroud element about a first transverse axis of the shroud element and a second transverse axis of the shroud element.

### PRIORITY CLAIM

This application claims priority to U.S. Prov. Pat. Appl. No. 62/531,817 filed Jul. 12, 2017 the contents of which are hereby incorporated by reference in their entirety as if fully set forth herein.

### COPYRIGHT NOTICE

This disclosure is protected under United States and/or International Copyright Laws. © 2018 Jetoptera, Inc. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyrights whatsoever.

### BACKGROUND

The design of an aircraft or drone more generally consists of its propulsive elements and the airframe into which those elements are integrated. Conventionally, the propulsive device in aircraft can be a turbojet, turbofan, turboprop or turboshaft, piston engine, or an electric motor equipped with a propeller. The propulsive system (propulsor) in small unmanned aerial vehicles (UAVs) is conventionally a piston engine or an electric motor which provides power via a shaft to one or several propellers. The propulsor for a larger aircraft, whether manned or unmanned, is traditionally a jet engine or a turboprop. The propulsor is generally attached to the fuselage or the body or the wings of the aircraft via pylons or struts capable of transmitting the force to the aircraft and sustaining the loads. The emerging mixed jet (jet efflux) of air and gases is what propels the aircraft in the opposite direction to the flow of the jet efflux.

Conventionally, the air stream efflux of a large propeller is not used for lift purposes in level flight and a significant amount of kinetic energy is hence not utilized to the benefit of the aircraft, unless it is swiveled as in some of the applications existing today (namely the Bell Boeing V-22 Osprey). Rather, the lift on most existing aircraft is created by the wings and tail. Moreover, even in those particular VTOL applications (e.g., take-off through the transition to level flight) found in the Osprey, the lift caused by the propeller itself is minimal during level flight, and most of the lift force is nonetheless from the wings.

The current state of art for creating lift on an aircraft is to generate a high-speed airflow over the wing and wing elements, which are generally airfoils. Airfoils are characterized by a chord line extended mainly in the axial direction, from a leading edge to a trailing edge of the airfoil. Based on the angle of attack formed between the incident airflow and the chord line, and according to the principles of airfoil lift generation, lower pressure air is flowing over the suction (upper) side and conversely, by Bernoulli law, moving at higher speeds than the lower side (pressure side). The lower the airspeed of the aircraft, the lower the lift force, and higher surface area of the wing or higher angles of incidence are required, including for take-off.

Large UAVs make no exception to this rule. Lift is generated by designing a wing airfoil with the appropriate angle of attack, chord, wingspan, and camber line. Flaps, slots and many other devices are other conventional tools used to maximize the lift via an increase of lift coefficient and surface area of the wing, but it will be generating the lift corresponding to at the air-speed of the aircraft. (Increasing the area (S) and lift coefficient (C_{L}) allow a similar amount of lift to be generated at a lower aircraft airspeed (V0) according to the formula L=½ ρV²SC_{L}, but at the cost of higher drag and weight.) These current techniques also perform poorly with a significant drop in efficiency under conditions with high cross winds.

While smaller UAVs arguably use the thrust generated by propellers to lift the vehicle, the current technology strictly relies on control of the electric motor speeds, and the smaller UAV may or may not have the capability to swivel the motors to generate thrust and lift, or transition to a level flight by tilting the propellers. Furthermore, the smaller UAVs using these propulsion elements suffer from inefficiencies related to batteries, power density, and large propellers, which may be efficient in hovering but inefficient in level flight and create difficulties and danger when operating due to the fast-moving tip of the blades. Most current quadcopters and other electrically powered aerial vehicles are only capable of very short periods of flight and cannot efficiently lift or carry large payloads, as the weight of the electric motor system and battery may already be well exceeding 70% of the weight of the vehicle at all times of the flight. A similar vehicle using jet fuel or any other hydrocarbon fuel typically used in transportation will carry more usable fuel by at least one order of magnitude. This can be explained by the much higher energy density of the hydrocarbon fuel compared to battery systems (by at least one order of magnitude), as well as the lower weight to total vehicle weight ratio of a hydrocarbon-fuel-based system.

Accordingly, there is a need for enhanced efficiency, improved capabilities, and other technological advancements in aircraft, particularly to UAVs and certain manned aerial vehicles.

### BRIEF DESCRIPTION OF THE DRAWING FIGURES

FIG. 1 illustrates a cross-sectional view of a thruster and shroud according to an embodiment;

FIG. 2 is a side perspective view of the shroud illustrated in FIG. 1;

FIGS. 3A-3C illustrate a side cross-sectional views of the shroud illustrated in FIG. 1 in both standard and deflected orientations;

FIG. 4 illustrates a cross-sectional view of a thruster and shroud according to an embodiment;

FIG. 5 illustrates a side view of a thruster according to an embodiment;

FIGS. 6-7 illustrate cross-sectional views of the thruster illustrated in FIG. 5; and

FIG. 8 illustrates a side perspective view of the thruster illustrated in FIG. 5.

### DETAILED DESCRIPTION

This application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms. In addition, the headings in this application are for reference purposes only and shall not in any way affect the meaning or interpretation of the present invention.

An embodiment includes an augmentation shroud designed for augmenting the thrust of a fluid emitted from the nozzle of a propulsive device such as a turbojet. The shroud can be variably oriented via, for example, a gimbaling mechanism that allows the inlet to the shroud to stay mainly annular to the turbojet's exit nozzle while entraining secondary air in the gap of the annulus and while directing the mixed flow resulting from the entrainment and mixing of the hot stream and cold entrained stream in a conic envelope at a predetermined angle from the centerline of the turbojet exhaust nozzle. The resulting mixture of hot and cold gases emerges from the exit end of the shroud at high velocity and is vectored in the desired direction.

A mechanism attaches the augmentation shroud to the aircraft or the jet engine housing or nacelle. The mechanism allows the rotation of the shroud in two fundamental directions relative to the exhaust nozzle (e.g., left/right and up/down, as well as combinations of same) via a gimbal or any other suitable means and around hinges placed at appropriate locations, and the combinations of the rotation movements. The jet engine and its exit nozzle stay fixed in one location with a rigid mounting on the aircraft, while the shroud can be moved around a solid angle envelope up to a predetermined angle, such as 60 degrees, via moving levers that transmit the move from a servomotor, for example, to the shroud.

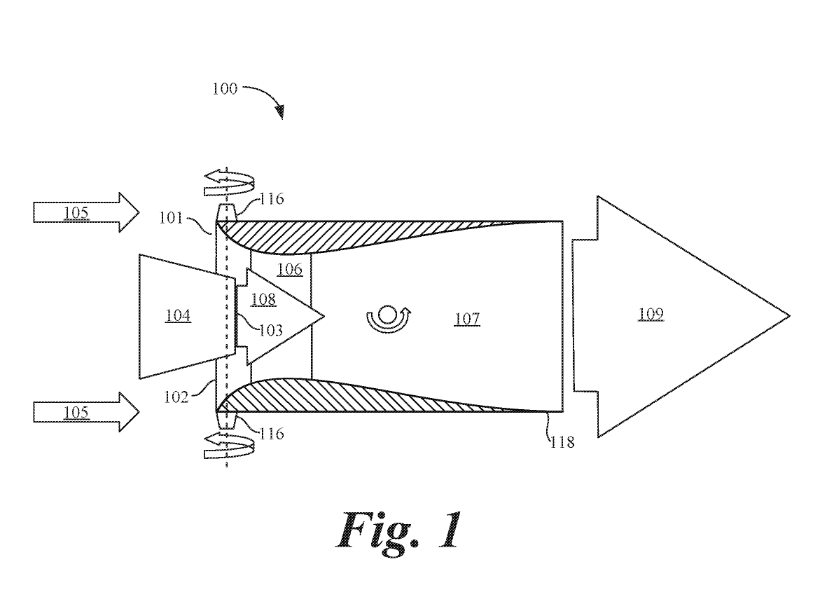

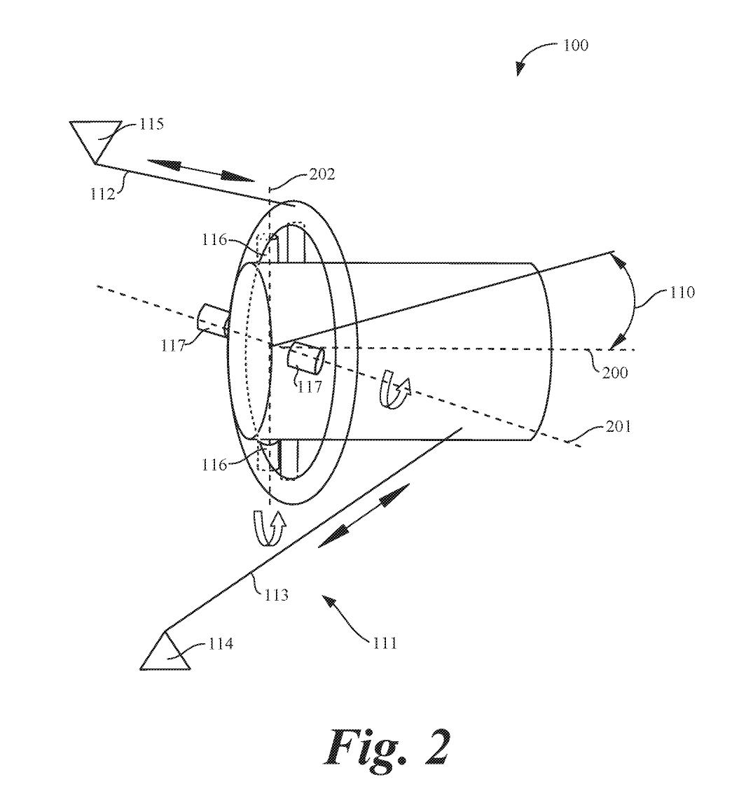

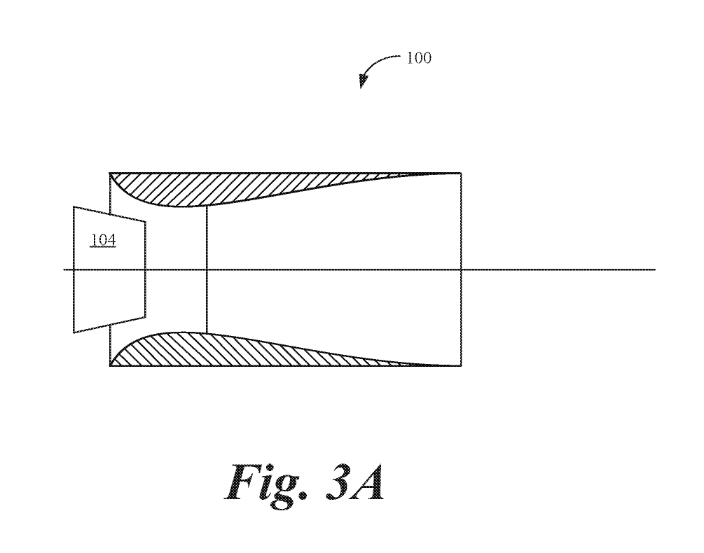

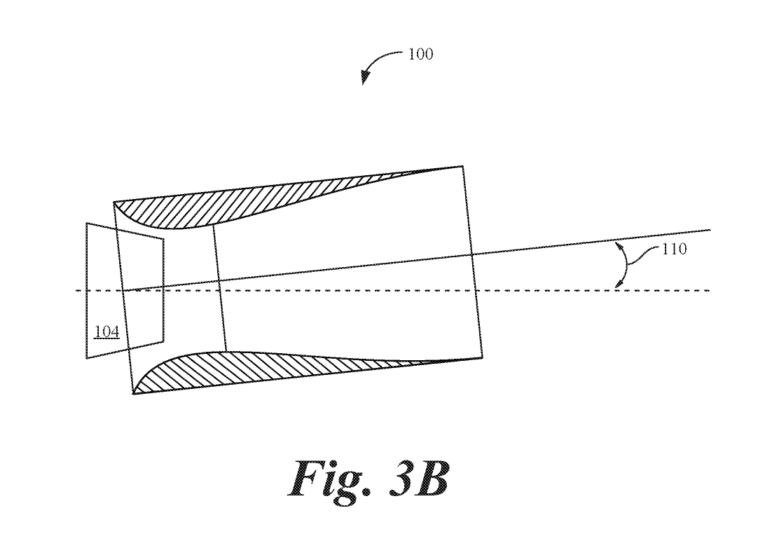

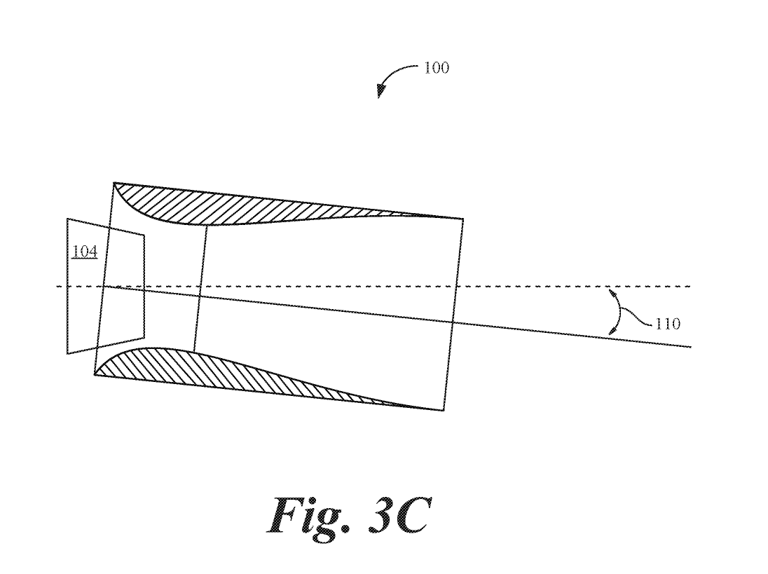

FIGS. 1-3C illustrate an embodiment of the invention. A shroud element 100 includes an entrainment inlet section 101 of, if round in configuration, diameter 102 and an outlet 118. In varying embodiments, the shroud 100 may be manufactured out of high temperature metal, composite or ceramic material. The inlet 101 is mainly concentric to the nozzle or propulsion fluid outlet 103 of a turbojet 104 or other propulsion device and stays mainly concentric even at the maximum angle of deflection 110 as illustrated in FIGS. 2 and 3B-3C. In an embodiment, outlet 103 is positioned inside of shroud 100 downstream of inlet section 101.

The role of entrainment section 101 is to facilitate the entrainment of secondary air 105 from the ambient into a throat section 106 of the shroud 100. The throat section 106 is designed to maximize the entrainment by minimizing local pressure within the throat section in order to create a massive amount of suction or entrainment of secondary air 105 into the throat section. An additional element of the shroud 100 is a mixing or diffusing section 107 downstream of the throat section 106 and fluid outlet 103 in which the mixing of the hot (primary) stream 108 (from turbojet 104) and colder secondary air 105 takes place and pressure recovery occurs. The resulting mixing jet 109 produces thrust greater than that produced solely by hot stream 108 while lowering the temperature of the mixed fluids proportional to the amount entrained.

As best illustrated in FIG. 2, the shroud 100 can be moved via a gimbal system 111 that includes actuating elements such as at least two levers 112, 113 driven by servomotors 114, 115 that act to deflect the shroud 100 relative to the centerline 200 of the turbojet 104. The shroud 100 includes hinges 116, 117 that are coincident with at least a portion of and allow rotation of shroud about transverse axes 201, 202. The shroud 100 is typically aligned concentrically with the centerline 200 of turbojet 104 during level flight and is rotated if a change in direction or attitude is required for an aircraft propelled by the turbojet 104. Such aircraft may employ one or two propulsion devices such as turbojet 104 with an attached shroud 100 and may be completely and exclusively controlled by movements/rotation of the shroud 100 for pitch, yaw, roll and thrust. Alternatively, other aerodynamic control surfaces may be employed to assist with aircraft control.

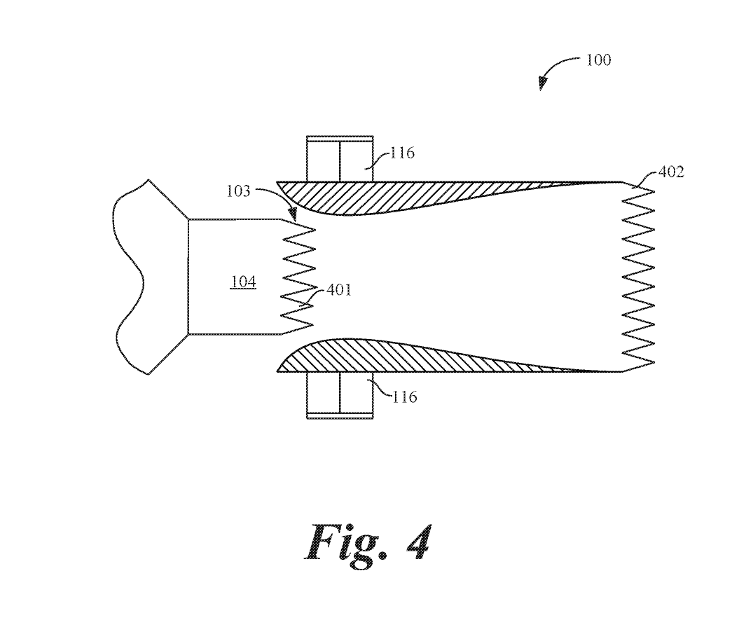

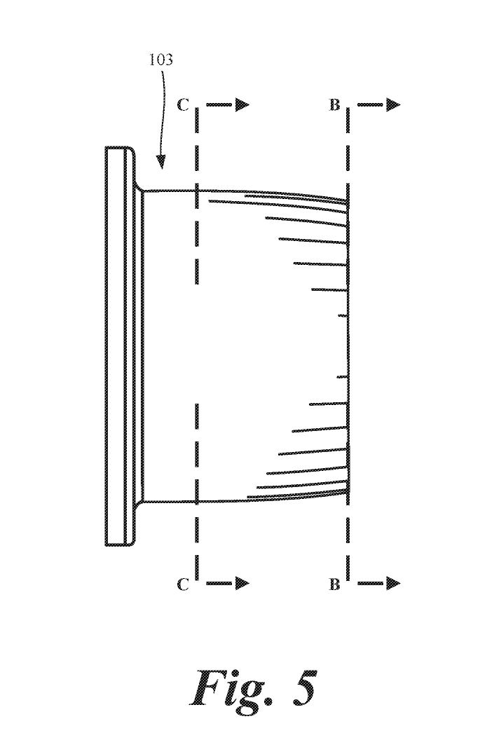

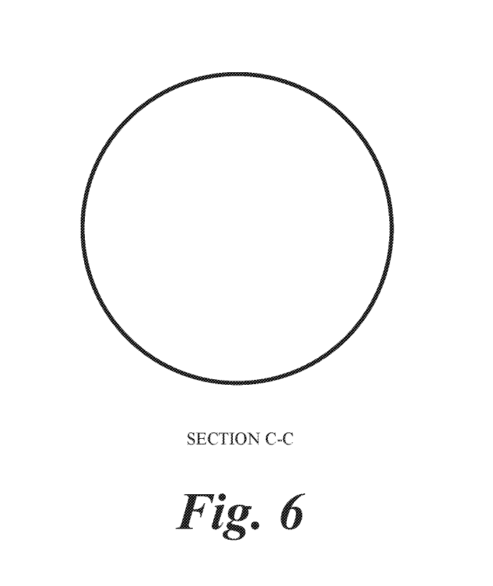

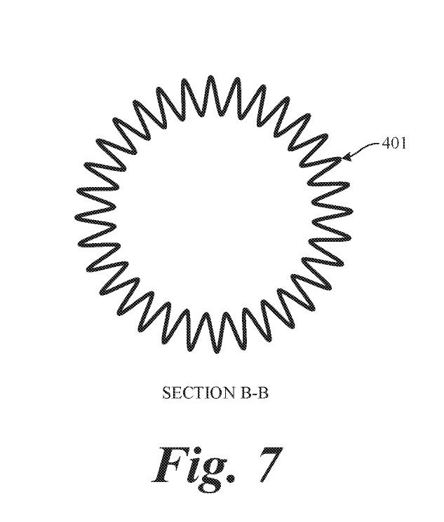

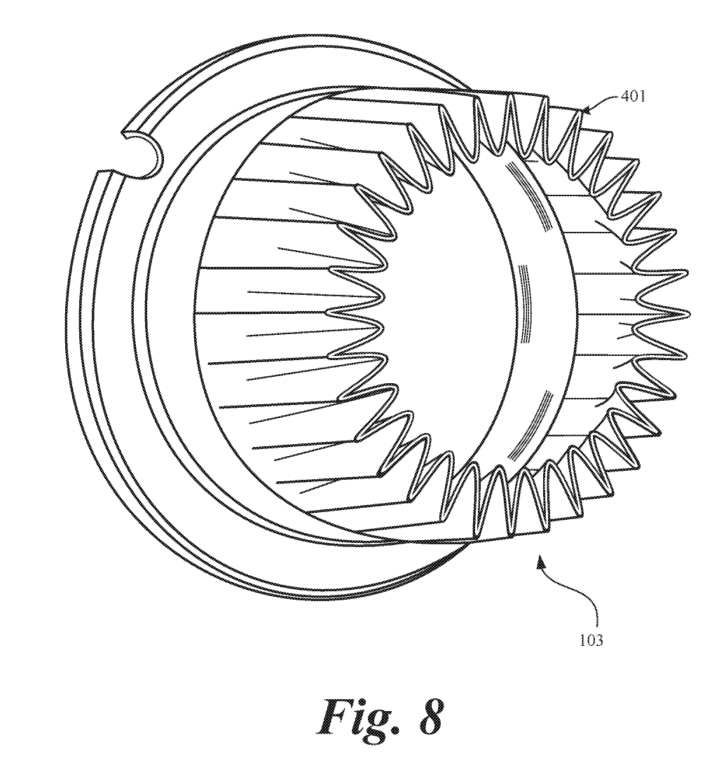

FIGS. 4-8 illustrates an embodiment of the invention. The embodiment illustrated in FIGS. 4-8 is identical to that illustrated in FIGS. 1-3C except for the following discussed features in which like elements are identified using like reference numerals. The exhaust nozzle 103 of turbojet 104 or other propulsion device can be machined to be coarse or otherwise irregular, such as, for example, serrated or ridged to include fringes 401. Similarly, the outlet portion of the shroud 100 can be machined to be coarse or otherwise irregular, such as, for example, serrated or ridged to include fringes 402. Fringes 401, 402 can serve to reduce noise, increase mixing and entrainment, and increase augmentation all while maintaining vectoring capabilities.

Although the foregoing text sets forth a detailed description of numerous different embodiments, it should be understood that the scope of protection is defined by the words of the claims to follow. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed is:

1. A system for enhancing the thrust produced by an aircraft propulsion element having a propulsion fluid outlet, the system comprising:
a shroud element comprising an inlet, an outlet and a diffusing section positioned between the shroud element inlet and shroud element outlet, the shroud element being coupled to the aircraft such that the diffusing section is positioned directly downstream of the propulsion fluid outlet; and
at least one actuator operable to rotate the shroud element about a first transverse axis of the shroud element and a second transverse axis of the shroud element.

2. The system of claim 1, wherein the shroud element further comprises a throat section positioned between the shroud element inlet and shroud element outlet, the diffusing section being downstream of the throat section.

3. The system of claim 1, further comprising hinges coincident with at least a portion of the first and second transverse axes and on which the shroud element is mounted, the hinges permitting rotation of the shroud element about the first and second transverse axes.

4. The system of claim 1, wherein the shroud element is coupled to the aircraft such that the diffusing section is positioned to simultaneously receive primary fluid from the propulsion fluid outlet and secondary fluid from the ambient.

5. The system of claim 1, wherein the shroud element outlet is serrated.

6. A propulsion system for an aircraft, comprising:
an aircraft propulsion element coupled to the aircraft and having a propulsion fluid outlet;
a shroud element comprising an inlet, an outlet and a diffusing section positioned between the shroud element inlet and shroud element outlet, the shroud element being coupled to the aircraft such that the diffusing section is positioned directly downstream of the propulsion fluid outlet; and
at least one actuator operable to rotate the shroud element about a first transverse axis of the shroud element and a second transverse axis of the shroud element.

7. The system of claim 6, wherein the shroud element further comprises a throat section positioned between the shroud element inlet and shroud element outlet, the diffusing section being downstream of the throat section.

8. The system of claim 6, further comprising hinges coincident with at least a portion of the first and second transverse axes and on which the shroud element is mounted, the hinges permitting rotation of the shroud element about the first and second transverse axes.

9. The system of claim 6, wherein the shroud element is coupled to the aircraft such that the diffusing section is positioned to simultaneously receive primary fluid from the propulsion fluid outlet and secondary fluid from the ambient.

10. The system of claim 6, wherein the shroud element outlet is serrated.

11. The system of claim 6, wherein the propulsion fluid outlet is serrated.

12. The system of claim 6, wherein the aircraft propulsion element comprises a turbojet.

13. An aircraft, comprising:
an aircraft propulsion element having a propulsion fluid outlet;
a shroud element comprising an inlet, an outlet and a diffusing section positioned between the shroud element inlet and shroud element outlet, the shroud element being configured such that the diffusing section is positioned directly downstream of the propulsion fluid outlet; and
at least one actuator operable to rotate the shroud element about a first transverse axis of the shroud element and a second transverse axis of the shroud element.

14. The aircraft of claim 13, wherein the shroud element further comprises a throat section positioned between the shroud element inlet and shroud element outlet, the diffusing section being downstream of the throat section.

15. The system of claim 13, further comprising hinges coincident with at least a portion of the first and second transverse axes and on which the shroud element is mounted, the hinges permitting rotation of the shroud element about the first and second transverse axes.

16. The system of claim 13, wherein the shroud element is coupled to the aircraft such that the diffusing section is positioned to simultaneously receive primary fluid from the propulsion fluid outlet and secondary fluid from the ambient.

17. The system of claim 13, wherein the shroud element outlet is serrated.

18. The system of claim 13, wherein the propulsion fluid outlet is serrated.

19. The system of claim 13, wherein the aircraft propulsion element comprises a turbojet.

20. The system of claim 13, wherein rotation of the shroud element is the sole means of controlling pitch, roll and yaw of the aircraft.
